(19) United States
(12) Patent Application Publication
(10) Pub. No.: US 2013/0315542 A1
(43) Pub. Date: Nov. 28, 2013

(54) CONNECTOR ASSEMBLY FOR OPTICAL FIBER

(71) Applicant: HOYA Corporation USA, Santa Clara, CA (US)

(72) Inventor: Rolf A. Wyss, Glendale, CA (US)

(73) Assignee: HOYA Corporation USA, Santa Clara, CA (US)

(21) Appl. No.: 13/680,061

(22) Filed: Nov. 18, 2012

Related U.S. Application Data
(60) Provisional application No. 61/609,361, filed on Mar. 11, 2012.

(51) Int. Cl. G02B 6/38

(52) U.S. Cl. CPC G02B 6/381
USPC 385/83; 29/428

(57) ABSTRACT

A connector assembly for an optical fiber comprises a unitary connector body and a fiber ferrule. The unitary connector body has an axial ferrule channel and a transverse passage connecting the ferrule channel and the connector body outer surface. The ferrule is positioned at least partly within the ferrule channel, and has an axial fiber channel and a transverse ferrule groove on its outer surface. The ferrule is positioned so that a volume defined by the ferrule groove and the ferrule channel surface communicates with the transverse passage. The connector assembly can further comprise a retaining member positioned at least partly within the ferrule groove and at least partly within the transverse passage. The retaining member comprises hardened material that had flowed, prior to hardening, (i) through the transverse passage into the ferrule groove and (ii) into the transverse passage.

### BENEFIT CLAIMS TO RELATED APPLICATIONS

This application claims benefit of U.S. provisional App. No. 61/609,361 filed Mar. 11, 2012 in the name of Rolf A. Wyss, said provisional application being hereby incorporated by reference as if fully set forth herein.

### BACKGROUND

The field of the present invention relates to connectors for optical fibers. In particular, apparatus and methods are described herein for securing a fiber ferrule within a connector assembly.

A wide variety of connector assemblies are available for connecting optical fibers. Some of these are described in:
U.S. Pat. No. 6,942,397 entitled “Packaging for a fiber-coupled optical device” issued Sep. 13, 2005 to Benzoni et al;
U.S. Pat. No. 7,223,025 entitled “Packaging for a fiber-coupled optical device” issued May 29, 2007 to Benzoni et al;
U.S. Pat. No. 7,543,993 entitled “Fiber-coupled optical device mounted on a circuit board” issued Jun. 9, 2009 to Blauvelt et al;
U.S. Pat. No. 7,625,132 entitled “Packaging for a fiber-coupled optical device” issued Dec. 1, 2009 to Benzoni et al; and
U.S. Pub. No. 2011/0235963 entitled “Fiber-coupled optoelectronic device mounted on a circuit board” filed Sep. 23, 2010 in the names of Benzoni et al.

Many varieties of connector assemblies exist for end-to-end coupling of optical fibers. Types of connectors include, but are not limited to, Avio (Avim), ADT-UNI, Biconic, D4, Deutsch 1000, DIN (LSA), DMI, E-2000 aka LSH, EC, ESCON, F07, F-3000, FC, Fibergate, FSMA, LC, ELIO, Lucxis, LX-5, MIC, MPO/MTP, MT, MT-RJ, MU, NEC D4, Opti-Jack, OPTIMATE, SC, SMA, SMC, ST/BFOC, TOSLINK, VF-45, 1053 HDTV, and V-PIN. LC and SC connectors currently are the most common commercially available connector assemblies. A common feature of many of the exemplary connector assemblies is an end of an optical fiber held in a fiber ferrule. The present disclosure or appended claims shall be construed as encompassing any connector for optical fiber employing a fiber ferrule.

The ferrule typically comprises a substantially cylindrical member with an axial bore for receiving the end of the optical fiber. The ferrule is formed from ceramic, metal, or certain polymers or plastics; the material employed is preferably substantially rigid and dimensionally stable. The axial bore is substantially concentric with respect to the ferrule outer surface; the precision required for that concentricity is dictated by the precision required for relative transverse positioning of the coupled optical fibers to achieve sufficiently small insertion loss for the fiber connection. The diameter of the axial bore is selected to accommodate the optical fiber while positioning it sufficiently precisely relative to the ferrule outer surface (again, to achieve sufficiently small insertion loss). The fiber typically is secured within the bore with epoxy or other suitable adhesive. Ferrules that are only partly cylindrical (e.g., that include a flange, notch, slot, or similar structural feature) or non-cylindrical also fall within the scope of the present disclosure or appended claims.

The end of the ferrule and the end of the fiber secured within it are typically polished together so that the end of the fiber is flush with an end surface of the ferrule. Various connection geometries are employed wherein the end of the ferrule, and the end of the fiber polished with it, are flat, slightly convex, substantially perpendicular to the ferrule axis, or slightly tilted relative to the ferrule axis (e.g., by about 8°). Air-gap or physical-contact arrangements can be employed for optically coupling two fibers end-to-end. Physical contact between the fiber ends reduces insertion loss and back reflection from the fiber connection; convex ferrule surfaces enable more reliable physical contact between the fiber ends. Index-matching gels or liquids are sometimes employed in an air-gap or physical contact arrangement to reduce insertion loss and back reflection. Angling the fiber end faces further reduces back reflection. All of those arrangements fall within the scope of the present disclosure or appended claims.

To achieve end-to-end coupling of two optical fibers 110/210, each fiber end is received (and polished) within a corresponding ferrule 120/220 as described above (FIGS. 1A and 1B). The two ferrules 120/220 are then positioned end-to-end within an alignment sleeve 130 that positions the ferrules 120/220 substantially coaxially (FIG. 1B); the precision required for that coaxial positioning is dictated by the precision required for relative transverse positioning of the coupled optical fibers 110/210 to achieve sufficiently small insertion loss for the fiber connection. If the ends of the ferrules 120/220 and fibers 110/210 are angled, then rotational alignment may be required as well. The alignment sleeve 130 can be a part of or attached to one of two mating connector assemblies 150/250 (one assembly for each of the two connected fibers 110/210; the alignment sleeve 130 is part of connector assembly 150 in FIGS. 1A and 1B), or can be a distinct component separate from both connector assemblies 150/250 (an arrangement not shown in the Drawings but shown, e.g., in U.S. Pat. No. 5,082,344); each of those arrangements falls within the scope of the present disclosure or appended claims.

In any of the exemplary fiber connector arrangements shown or described, the fibers 110/210 and corresponding ferrules 120/220 are attached to or held by the corresponding connector assemblies 150/250, which include corresponding connector body members 140/240. The ferrules 120/220 can be secured to the corresponding body members 140/240 in a variety of ways depending on the specific structure or construction of the connector assemblies 150/250. In some examples the ferrules 120/220 are movable relative to the corresponding body members 140/240 to facilitate mating of the connector assemblies 150/250 or alignment of the ferrules 120/220; in such examples the ferrules 120/220 can be spring-loaded or otherwise biased to facilitate or maintain such mating or alignment. In other examples the ferrules 120/220 can be substantially rigidly attached to or held by the corresponding body members 140/240. In various examples, an interference, friction, or press fit arrangement can be employed to substantially rigidly hold the ferrules 120/220. In other examples an adhesive or a retainer can be employed. In any of those examples, it is typically desired that the ferrules 120/220 remain secured to the corresponding body members 140/240 during typical use conditions, including if or when the connector assemblies 150/250 are pulled apart.

In one conventional exemplary arrangement of an optical fiber connector assembly (FIGS. 2A-2D), a slot or groove 342 is formed on an inside surface of the body member 340 of the connector assembly 350, and a corresponding groove or slot 322 is formed on the outer surface of the ferrule 320. Upon assembly of the ferrule 320 and the body member 340, the corresponding slots or grooves 322 and 342 at least partly align with one another (as in FIGS. 2A and 2B). A retaining member can be positioned within the aligned slots or grooves 322 and 342 so as to restrict or prevent movement of the ferrule 320 within the body member 340. A pin, ring, or other mechanical retaining member can be inserted into the aligned slots or grooves 322 and 342 (not shown in the Drawings); such a mechanical retaining member can be rigid or somewhat deformable. Instead or in addition, uncured, flowable adhesive can at least partly fill the aligned slots or grooves 322 and 342 and, upon hardening, can form a retaining member 360 (in addition to providing adhesion between the ferrule 320 and the body member 340; shown in FIG. 2D). One advantage of a retaining member 360 formed from hardened adhesive is that, even if adhesion between the body member 340 and ferrule 320 fails, the hardened retaining member 360 can nevertheless prevent or restrict movement of the ferrule 320. In the example shown, the body member 340 comprises two halves, the ferrule 320 is placed between the body halves (FIGS. 2A and 2B), the uncured adhesive flows into one or more of the slots or grooves 322 or 342, the body halves are assembled together to form the body 340 (FIGS. 2C and 2D), and the adhesive is allowed or caused to cure and harden to form the retaining member 360 within the aligned slots or grooves 322 and 342.

It may be desirable in some circumstances to employ a connector assembly 450 in which a channel for receiving the ferrule 420 is formed in a unitary body member 440 of the connector assembly 450 (as in FIGS. 3A-3C), i.e., a body member 440 that is not divided into halves as in the example of FIGS. 2A-2D. Such a channel formed in a unitary body member 440 of the connector assembly 450 typically is arranged to receive the ferrule 420 with a relatively tight fit tolerance (such as an interference fit or press fit arrangement). It may be desirable to employ a hardened adhesive retaining member 460 (as described above) in a ferrule groove 422 and in a channel groove 442 in the unitary body member 440 as in FIG. 3A, which illustrates schematically an idealized application of adhesive only within grooves 422 and 442. Such well-controlled application of the flowing adhesive is problematic, however, due to the unitary construction of the body member 440 and the typically tight fit of the ferrule 420 within the unitary body member 440. Simply depositing adhesive within the body member 440 or on the ferrule 420 does not ensure the aligned slots or grooves 422 or 442 are adequately filled with adhesive, and typically results in excess adhesive in locations where it is not needed or even problematic. For example, depositing adhesive on the ferrule 420 prior to insertion into the unitary body member 440 can result in excess adhesive 462 on the end face or outer surface of the ferrule 420 that protrudes from the body member 440 (as in FIG. 3B), possibly interfering with proper engagement of the ferrule 420 with the sleeve 430. Depositing adhesive within the body member 440 can result in excess adhesive 462 on the back surface of the ferrule 420 (as in FIG. 3C), potentially interfering with insertion of the fiber 410 into the ferrule 420. In neither of those examples (FIGS. 3B and 3C) is adequate filling of the aligned slots or grooves 422 and 442 to form retaining member 460 ensured. Applying adhesive both within the unitary body member 440 and on the ferrule 420 might result in adequate filling of grooves 422 and 442 to form retaining member 460, but can leave adhesive residue 462 on both ends of ferrule 420 (not shown in the Drawings).

It is therefore desirable to provide an optical fiber connector assembly in which a ferrule is received within a channel formed in a unitary body portion of the connector assembly, and in which flowing adhesive can be deployed to adequately fill aligned slots or grooves on the ferrule and body without depositing unwanted adhesive on the surface or one or both ends of the ferrule.

### SUMMARY

A connector assembly for an optical fiber comprises a unitary connector body and a fiber ferrule. The unitary connector body has (i) an integrally formed axial ferrule channel formed therethrough and (ii) an integrally formed transverse passage connecting the ferrule channel and an outer surface of the connector body. The fiber ferrule is positioned at least partly within the ferrule channel, and has (i) an axial fiber channel formed therethrough and (ii) a transverse ferrule groove on an outer surface thereof. The fiber ferrule is positioned so that a volume defined by the ferrule groove and a surface of the ferrule channel communicates with the transverse passage. The connector assembly can further comprise a retaining member positioned at least partly within the ferrule groove and at least partly within the transverse passage. The retaining member comprises hardened material that had flowed, prior to hardening, (i) through the transverse passage into the ferrule groove and (ii) into the transverse passage.

Objects and advantages pertaining to connector assemblies for optical fibers may become apparent upon referring to the exemplary embodiments illustrated in the drawings and disclosed in the following written description or appended claims.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1A and 1B illustrate schematically a generic connector assembly for optical fiber.

FIGS. 2A-2D illustrate schematically a conventional connector assembly with a two-part connector body and grooves for receiving adhesive.

FIGS. 3A-3C illustrate schematically a conventional connector assembly with a unitary connector body

FIGS. 4A-4C illustrate schematically several embodiments of a connector assembly for optical fiber arranged according to the present disclosure or appended claims.

FIGS. 5A and 5B illustrate schematically an SC receptacle connector arranged according to the present disclosure or appended claims.

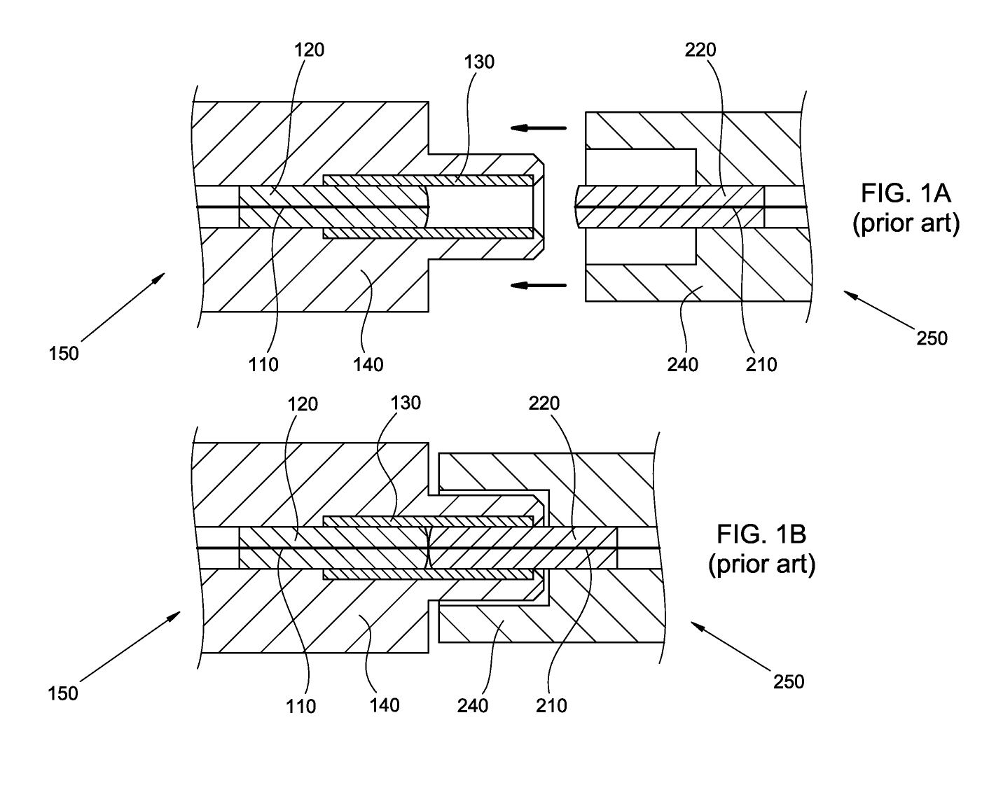

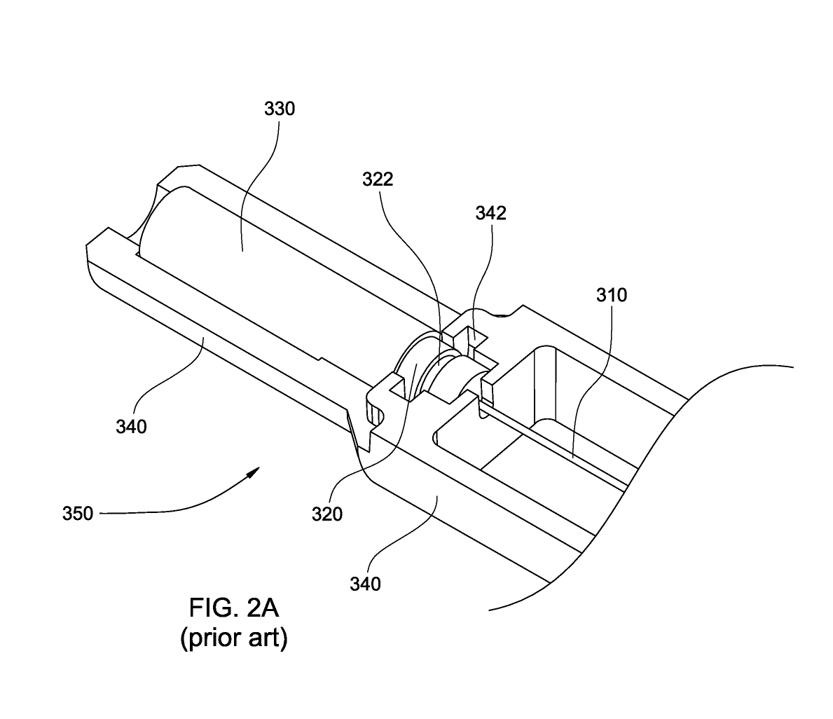

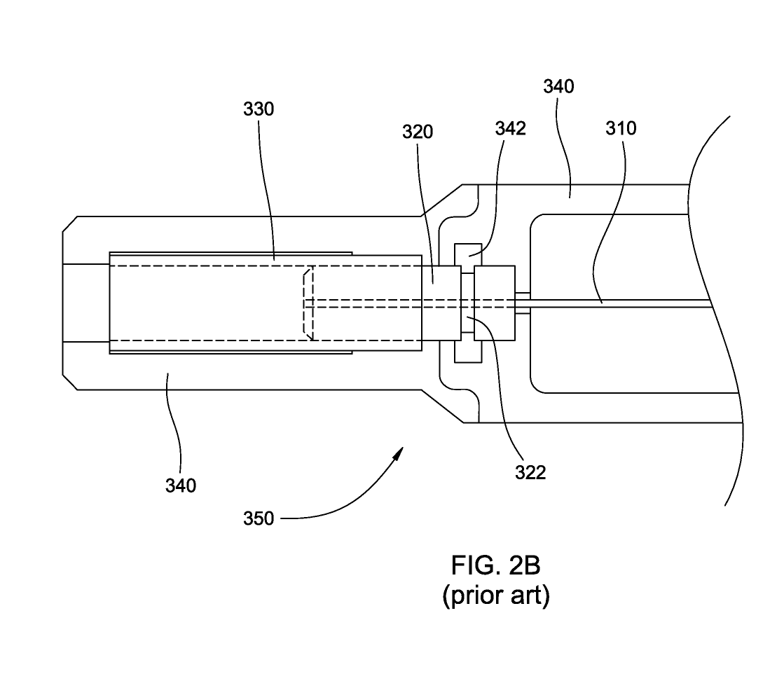

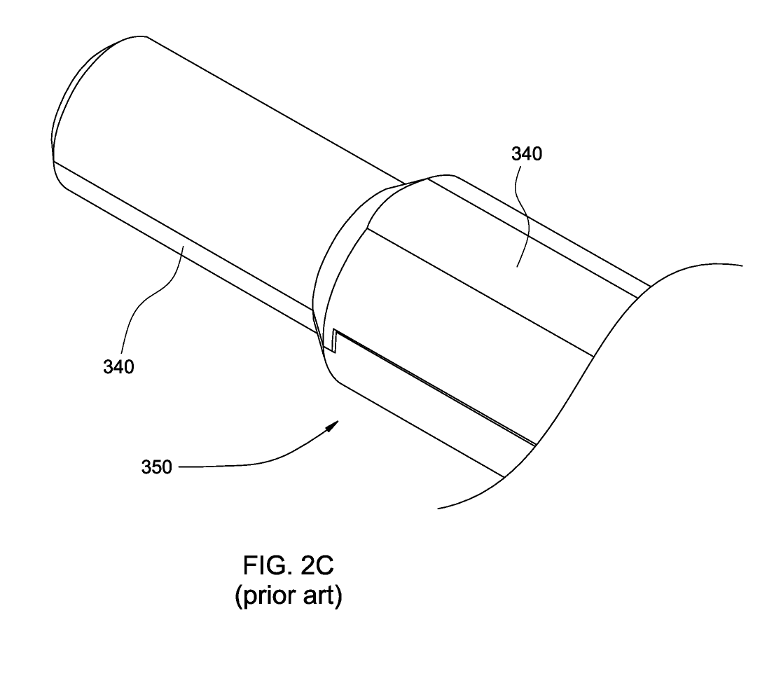

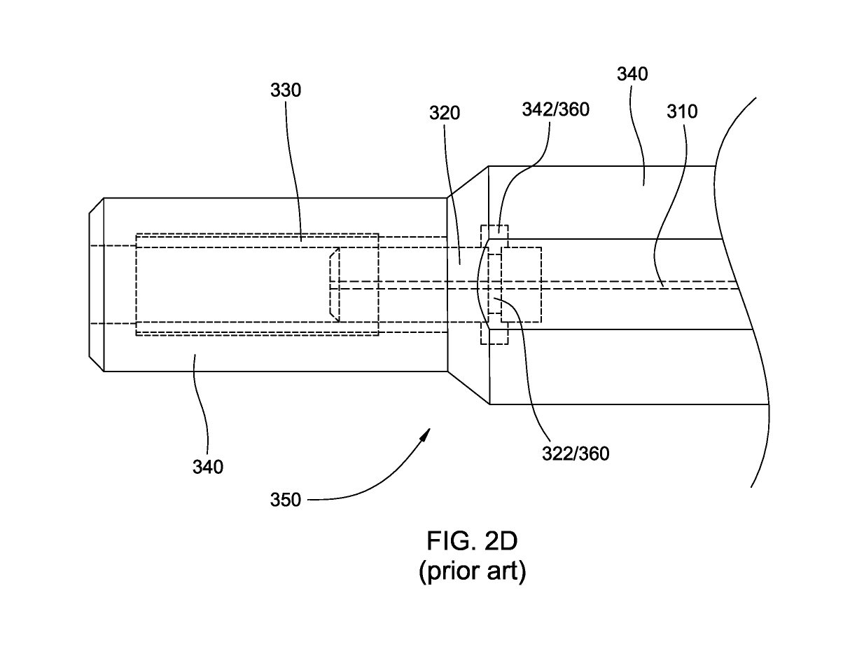

It should be noted that the embodiments depicted in this disclosure are shown only schematically, and that not all features may be shown in full detail or in proper proportion. Certain features or structures may be exaggerated relative to others for clarity. It should be noted further that the embodiments shown are exemplary only, and should not be construed as limiting the scope of the written description or appended claims.

### DETAILED DESCRIPTION OF EMBODIMENTS

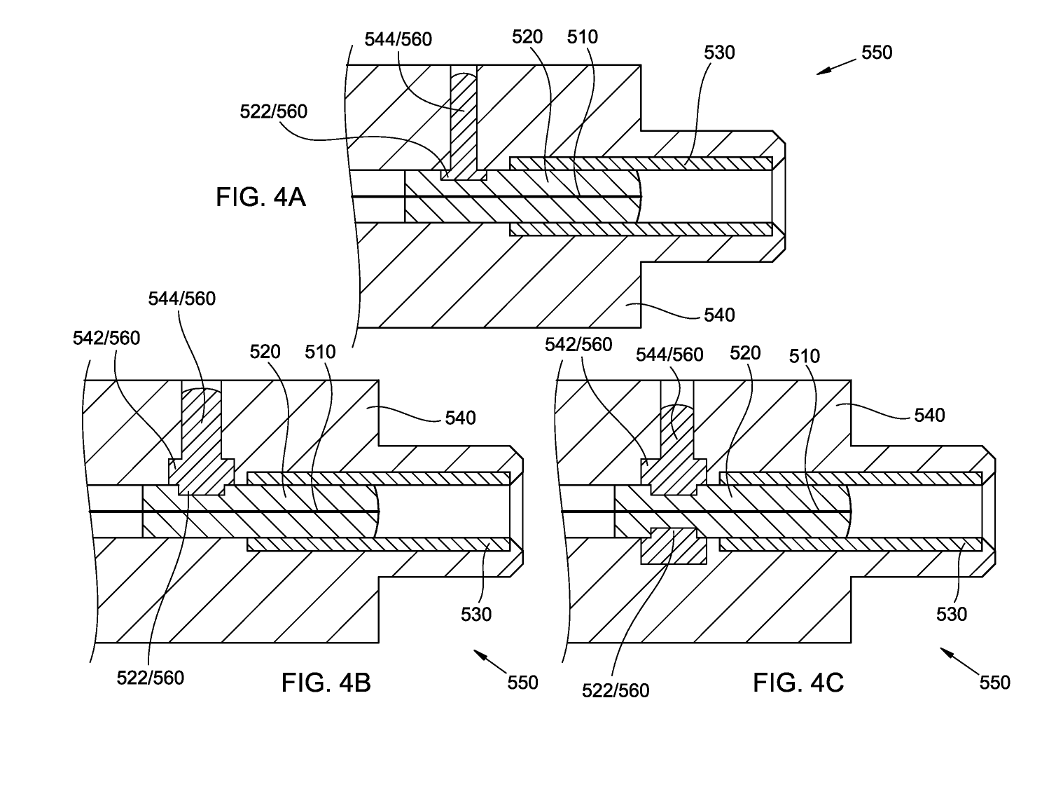

FIGS. 4A-4C illustrate several embodiments of a connector assembly for optical fiber. The connector assembly 550 comprises a unitary connector body 540 and a fiber ferrule 520. The unitary connector body has (i) an integrally formed axial ferrule channel formed therethrough and (ii) an integrally formed transverse passage 544 connecting the ferrule channel and an outer surface of the connector body 540. The fiber ferrule 520 is positioned at least partly within the ferrule channel. The ferrule 520 has (i) an axial fiber channel formed therethrough and (ii) a transverse ferrule groove 522 on its outer surface. The fiber ferrule 520 is positioned so that a volume defined by the ferrule groove 522 and a surface of the ferrule channel communicates with the transverse passage 544. The connector body 540 can comprise any suitable material, e.g., any of a variety of metals, ceramic, or plastics typically employed for forming fiber connectors. Likewise, the ferrule can comprise any suitable material, e.g., any of a variety of metallic materials (such as stainless steel), ceramic materials (such a zirconia), plastic materials, or other materials that are typically employed for forming fiber ferrules. Later-developed materials can be employed for either purpose and shall fall within the scope of the present disclosure or appended claims. The ferrule groove 522 can be arranged in any suitable way, including extending completely or only partly around the transverse perimeter of the ferrule 520 (e.g., the circumference of a cylindrical ferrule), or having a flat, polygonal, circular, elliptical, oval, or other cross sectional shape (for a cross section transverse to the fiber axis).

The connector assembly 550 can further comprise a retaining member 560 positioned at least partly within the ferrule groove 522 and at least partly within the transverse passage 544. The retaining member 560 comprises (i) hardened material that had flowed, prior to hardening, through the transverse passage 544 into the ferrule groove 522 and (ii) hardened material that had flowed, prior to hardening, into the transverse passage 544. The hardened material can comprise, e.g., cured polymer of any suitable type (e.g., epoxy adhesive, liquid in its uncured state), reflowed polymer of any suitable type, reflowed solder of any suitable type, reflowed glass of any suitable type, or fused glass frit or any suitable type. “Any suitable type” denotes materials that, upon hardening, are sufficiently rigid for the retaining member 560 to retain the ferrule 520 within the connector body 540 under typically use conditions, and that have properties and processing requirements that are compatible with materials of the ferrule 520, the connector body 540, or other elements of the connector assembly 550.

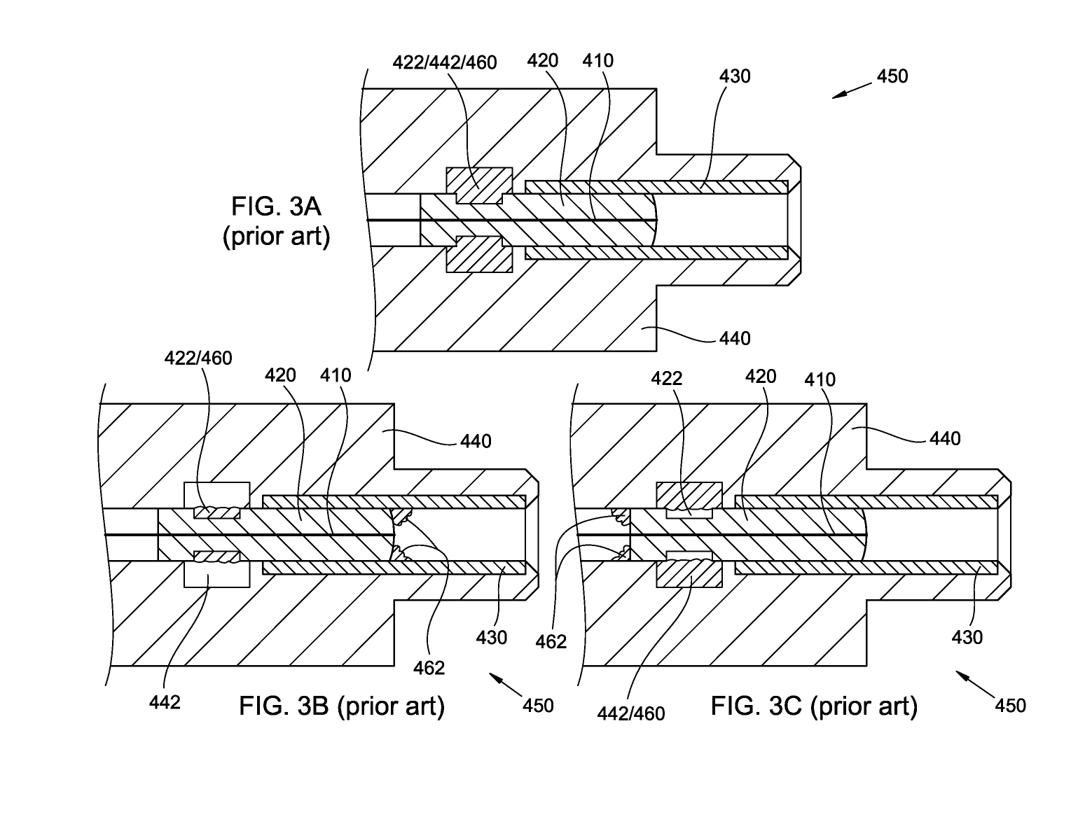

The arrangements of FIGS. 4A-4C, including the transverse passage 544 in the unitary connector body 540, avoid the problems suffered by the arrangements of FIGS. 3A-3C. Because the flowing material is not applied until after the ferrule 520 has been inserted into the ferrule channel of the unitary body 540, there is no residue on either end face of the fiber ferrule 520 (unlike the residue 462 on the end faces of ferrule 420 in FIGS. 3B or 3C). The presence of the transverse passage 544 enables flowing material to reach and at least partly fill the ferrule groove 522 despite the unitary construction of the connector body 540; the resulting retaining member thus adequately engages the ferrule 520 to retain it within the connector body 540. The presence of some of the hardened material in the transverse passage 544 ensures that the hardened retaining member 560 adequately engages the unitary connector body 540 to retain the fiber ferrule 520 within the connector body 540.

A method for making the connector assembly 550 comprises: (a) positioning the fiber ferrule 520 at least partly within the ferrule channel formed through the unitary connector body 540; (b) flowing material (i) into the transverse passage 544 and (ii) through the transverse passage 544 into the ferrule groove 522; and (c) after flowing the material, allowing or causing the flowed material to harden to form a retaining member 560 positioned at least partly within the ferrule groove 522 and at least partly within the transverse passage 544. Allowing or causing the material to harden can include, e.g., heat or ultraviolet curing of a polymer, or cooling of reflowed or fused material.

In some embodiments (e.g., FIGS. 4A and 4B), the ferrule groove 522 extends only partly around a transverse perimeter of the ferrule 520, so that the retaining member 560 can limit rotation of the ferrule 520 within the ferrule channel about an axis parallel to the axial fiber channel. An example of such an asymmetrical ferrule channel can include, e.g., one or more flat-bottomed slots formed across a lateral surface of a substantially cylindrical ferrule 520. Other various arrangements can be employed in which the ferrule groove 522 extends only partly around the transverse perimeter of ferrule 520. Alternatively, a slot that does extend completely around the ferrule 520 (as in FIG. 4C) can be employed that has an elliptical, oval, polygonal, or otherwise non-circular cross section (not shown) instead of a circular cross section in order to limit rotation of the ferrule 520 within the connector body 540.

In some embodiments, the unitary connector body 540 has an integrally formed transverse channel groove 542 on the ferrule channel surface (as in FIGS. 4B and 4C). The channel groove 542 is positioned so that a volume defined by the channel groove 542 and a surface of the ferrule 520 communicates with the volume defined by the ferrule groove 522 and the surface of the ferrule channel. In some examples, the volume defined by the channel groove 542 and a surface of the ferrule 520 communicates directly with the transverse passage 544 (as in FIG. 4B and 4C). In other examples (not shown), there is no direct communication between the transverse passage 544 and the channel groove 542, only indirect communication through the ferrule groove 522.

In embodiments that include a channel groove 542 (as in FIGS. 4B and 4C), the retaining member 560 is positioned at least partly within the ferrule groove 522 and at least partly within the channel groove 542. The retaining member 560 comprises hardened material that had flowed, prior to hardening, through the transverse passage 544 into the ferrule groove 522 and into the channel groove 542. It is often but not necessarily the case with such embodiments that the retaining member 560 also extends into the transverse passage 544. In embodiments that include a channel groove 542, the channel groove can extend completely or only partly around a transverse perimeter of the ferrule channel. The same variety of arrangements described above for the ferrule groove 522 can also be employed for the channel groove 542. The ferrule groove 522 and the channel groove 542 can but need not employ the same arrangement (e.g., need not have the same cross sectional shape, or need not extend around the same portion of the perimeter).

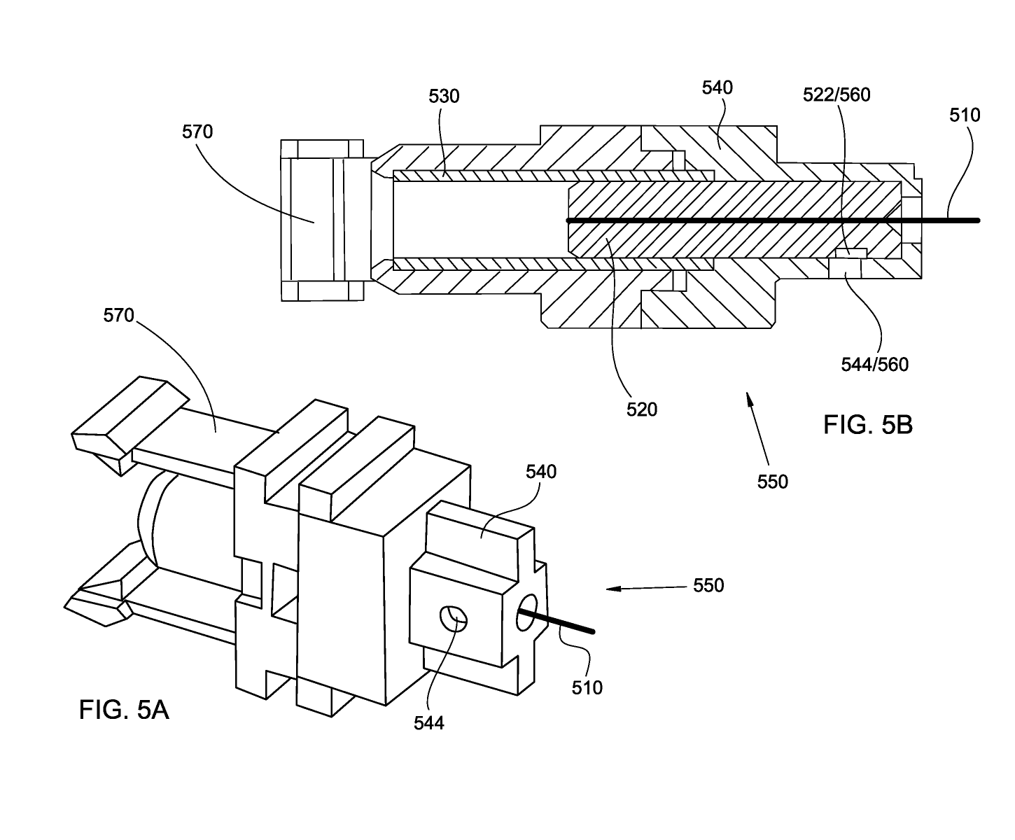

Another exemplary embodiment is illustrated schematically in FIGS. 5A and 5B in which the connector assembly 550 takes the form of a standard SC receptacle. The ferrule 520 is inserted into the ferrule channel in connector body 540. The transverse passage 544 through one side of the connector body 540 communicates with the transverse ferrule groove 522 on the fiber ferrule 520. Hardened material within the ferrule groove 522 and the transverse passage 544 form a retaining member 560 that retains the fiber ferrule 520 within the connector housing 540.

The exemplary connector assemblies of FIGS. 4A-4C and 5A-5B can further comprise a ferrule sleeve 530 attached to the unitary body 540 in a substantially coaxial arrangement with the fiber ferrule 520. Typically, at least a portion of the fiber ferrule 520 is positioned within the ferrule sleeve 530 to facilitate alignment with another fiber ferrule of a mating connector assembly. Typically, at least a portion of the ferrule sleeve 530 is not occupied by the fiber ferrule 520 to accommodate the other fiber ferrule of the mating connector. The ferrule sleeve 530 can comprise any suitable material, e.g., metal (such as phosphor bronze), plastic, or ceramic.

The exemplary connector assemblies of FIGS. 4A-4C and 5A-5B can further comprise the optical fiber 510 received and secured within the fiber channel of fiber ferrule 520. Any suitable type of optical fiber can be employed that is desired to be connected to another fiber, including but not limited to single-mode fiber, multi-mode fiber, or polarization-preserving fiber.

The exemplary connector assemblies of FIGS. 4A-4C and 5A-5B can further comprise a housing attached to or integrally formed with the unitary body 540. For example, the SC receptacle illustrated schematically in FIGS. 5A-5B includes a housing with resilient catch members 570 arranged to catch and retain a mating SC plug. Any suitable housing adapted for any suitable purpose shall fall within the scope of the present disclosure or appended claims.

In addition to the preceding, the following examples also fall within the scope of the present disclosure or appended claims:

### EXAMPLE 1

A connector assembly for an optical fiber, the connector assembly comprising: a unitary connector body having (i) an integrally formed axial ferrule channel formed therethrough and (ii) an integrally formed transverse passage connecting the ferrule channel and an outer surface of the connector body; and a fiber ferrule positioned at least partly within the ferrule channel, said ferrule having (i) an axial fiber channel formed therethrough and (ii) a transverse ferrule groove on an outer surface thereof, wherein the fiber ferrule is positioned so that a volume defined by the ferrule groove and a surface of the ferrule channel communicates with the transverse passage.

### EXAMPLE 2

The connector assembly of Example 1 further comprising a retaining member positioned at least partly within the ferrule groove and at least partly within the transverse passage, wherein said retaining member comprises (i) hardened material that had flowed, prior to hardening, through the transverse passage into the ferrule groove and (ii) hardened material that had flowed, prior to hardening, into the transverse passage.

### EXAMPLE 3

The connector assembly of Example 2 wherein the ferrule groove extends only partly around a transverse perimeter of the ferrule, so that the retaining member limits rotation of the ferrule within the ferrule channel about an axis parallel to the axial fiber channel.

### EXAMPLE 4

The connector assembly of Example 1 wherein the unitary body has an integrally formed transverse channel groove on the ferrule channel surface positioned so that a volume defined by the channel groove and a surface of the ferrule communicates with the volume defined by the ferrule groove and the surface of the ferrule channel.

### EXAMPLE 5

The connector assembly of Example 4 wherein the volume defined by the channel groove and a surface of the ferrule communicates with the transverse passage.

### EXAMPLE 6

The connector assembly of any one of Examples 4 or 5 further comprising a retaining member positioned at least partly within the ferrule groove and at least partly within the channel groove, wherein said retaining member comprises hardened material that had flowed, prior to hardening, through the transverse passage into the ferrule groove and into the channel groove.

### EXAMPLE ∂

The connector assembly of Example 6 wherein the ferrule groove extends only partly around a transverse perimeter of the ferrule or the channel groove extends only partly around a transverse perimeter of the ferrule channel, so that the retaining member limits rotation of the ferrule within the ferrule channel about an axis parallel to the axial fiber channel.

### EXAMPLE 8

The connector assembly of any one of Examples 2, 3, 6, or 7 wherein the hardened material comprises cured polymer, reflowed polymer, reflowed solder, reflowed glass, or fused glass frit.

### EXAMPLE 9

The connector assembly of any one of Examples 1 through 8 further comprising a ferrule sleeve attached to the unitary body in a substantially coaxial arrangement with the fiber ferrule.

### EXAMPLE 10

The connector assembly of Example 9 wherein at least a portion of the fiber ferrule is positioned within the ferrule sleeve and at least a portion of the ferrule sleeve is not occupied by the fiber ferrule.

### EXAMPLE 11

The connector assembly of any one of Examples 1 through 10 further comprising an optical fiber positioned within the fiber channel.

### EXAMPLE 12

The connector assembly of any one of claims 1 through 11 further comprising a housing attached to or integrally formed with the unitary body.

### EXAMPLE 13

The connector assembly of any one of Examples 1 through 12 further comprising a connecting member attached to or integrally formed with the unitary body, said connecting member being arranged to engage and retain a mating connector component or assembly.

### EXAMPLE 14

A method for making a connector assembly for an optical fiber, the method comprising positioning a fiber ferrule at least partly within a ferrule channel formed through a unitary connector body, wherein: the unitary connector body has (i) the integrally formed axial ferrule channel formed therethrough and (ii) an integrally formed transverse passage connecting the ferrule channel and an outer surface of the connector body; the fiber ferrule has (i) an axial fiber channel formed therethrough and (ii) a transverse ferrule groove on an outer surface thereof; and the fiber ferrule is positioned so that a volume defined by the ferrule groove and a surface of the ferrule channel communicates with the transverse passage.

### EXAMPLE 15

The method of Example 14 further comprising: flowing material (i) into the transverse passage and (ii) through the transverse passage into the ferrule groove; and after flowing the material, allowing or causing the flowed material to harden to form a retaining member positioned at least partly within the ferrule groove and at least partly within the transverse passage.

### EXAMPLE 16

The method of Example 15 wherein the ferrule groove extends only partly around a transverse perimeter of the ferrule, so that the retaining member limits rotation of the ferrule within the ferrule channel about an axis parallel to the axial fiber channel.

### EXAMPLE 17

The method of Example 14 wherein the unitary body has an integrally formed transverse channel groove on the ferrule channel surface positioned so that a volume defined by the channel groove and a surface of the ferrule communicates with the volume defined by the ferrule groove and the surface of the ferrule channel.

### EXAMPLE 18

The method of Example 17 wherein the volume defined by the channel groove and a surface of the ferrule communicates with the transverse passage.

### EXAMPLE 19

The method of any one of Examples 17 or 18 further comprising: flowing material through the transverse passage into the ferrule groove and the channel groove; and after flowing the material, allowing or causing the flowed material to harden to form a retaining member positioned at least partly within the ferrule groove and at least partly within the channel groove.

### EXAMPLE 20

The method of Example 19 wherein the ferrule groove extends only partly around a transverse perimeter of the ferrule or the channel groove extends only partly around a transverse perimeter of the ferrule channel, so that the retaining member limits rotation of the ferrule within the ferrule channel about an axis parallel to the axial fiber channel.

### EXAMPLE 21

The method of any one of Examples 15, 16, 19, or 20 wherein the hardened material comprises cured polymer, reflowed polymer, reflowed solder, reflowed glass, or fused glass frit.

### EXAMPLE 22

The method of any one of Examples 14 through 21 further comprising attaching a ferrule sleeve to the unitary body in a substantially coaxial arrangement with the fiber ferrule.

### EXAMPLE 23

The method of Example 22 wherein at least a portion of the fiber ferrule is positioned within the ferrule sleeve and at least a portion of the ferrule sleeve is not occupied by the fiber ferrule.

### EXAMPLE 24

The method of any one of Examples 14 through 23 further comprising positioning an optical fiber within the fiber channel.

### EXAMPLE 25

The method of any one of Examples 14 through 24 further comprising attaching a housing to, or integrally forming a housing with, the unitary body.

### EXAMPLE 26

The method of any one of Examples 14 through 25 further comprising attaching a connecting member to, or integrally forming a connecting member with, the unitary body, said connecting member being arranged to engage and retain a mating connector component or assembly.

### EXAMPLE 27

A method for making a connector assembly for an optical fiber, the method comprising forming through a unitary connector body (i) an integrally formed axial ferrule channel and (ii) an integrally formed transverse passage connecting the ferrule channel and an outer surface of the connector body, the channel and the passage being arranged so that with a fiber ferrule positioned at least partly within the ferrule channel, said ferrule having (i) an axial fiber channel formed therethrough and (ii) a transverse ferrule groove on an outer surface thereof, a volume defined by the ferrule groove and a surface of the ferrule channel communicates with the transverse passage.

### EXAMPLE 28

The method of Example 27 further comprising forming the transverse ferrule groove on the fiber ferrule.

### EXAMPLE 29

The method of any one of Examples 27 or 28 wherein the ferrule groove extends only partly around a transverse perimeter of the ferrule.

### EXAMPLE 30

The method of any one of Examples 27, 28, or 29 further comprising forming a transverse channel groove on the ferrule channel surface of the unitary body, the channel groove and the ferrule groove being arranged so that with the fiber ferrule positioned at least partly within the ferrule channel a volume defined by the channel groove and a surface of the ferrule communicates with the volume defined by the ferrule groove and the surface of the ferrule channel.

### EXAMPLE 31

The method of Example 30 wherein the channel groove and the ferrule groove are arranged so that with the fiber ferrule positioned at least partly within the ferrule channel the volume defined by the channel groove and a surface of the ferrule communicates with the transverse passage.

### EXAMPLE 32

The method of any one of Examples 30 or 31 wherein the ferrule groove extends only partly around a transverse perimeter of the ferrule or the channel groove extends only partly around a transverse perimeter of the ferrule channel.

### EXAMPLE 33

The method of any one of Examples 27 through 32 further comprising attaching a housing to, or integrally forming a housing with, the unitary body.

### EXAMPLE 34

The method of any one of Examples 27 through 33 further comprising attaching a connecting member to, or integrally forming a connecting member with, the unitary body, said connecting member being arranged to engage and retain a mating connector component or assembly.

It is intended that equivalents of the disclosed exemplary embodiments and methods shall fall within the scope of the present disclosure or appended claims. It is intended that the disclosed exemplary embodiments and methods, and equivalents thereof, may be modified while remaining within the scope of the present disclosure or appended claims.

In the foregoing Detailed Description, various features may be grouped together in several exemplary embodiments for the purpose of streamlining the disclosure. This method of disclosure is not to be interpreted as reflecting an intention that any claimed embodiment requires more features than are expressly recited in the corresponding claim. Rather, as the appended claims reflect, inventive subject matter may lie in less than all features of a single disclosed exemplary embodiment. Thus, the appended claims are hereby incorporated into the Detailed Description, with each claim standing on its own as a separate disclosed embodiment. However, the present disclosure and appended claims shall also be construed as implicitly disclosing any embodiment having any suitable set of one or more disclosed or claimed features (i.e., sets of features that are not incompatible or mutually exclusive) that appear in the present disclosure or the appended claims, including those sets that may not be explicitly disclosed herein. It should be further noted that the scope of the appended claims do not necessarily encompass the whole of the subject matter disclosed herein.

For purposes of the present disclosure and appended claims, the conjunction “or” is to be construed inclusively (e.g., “a dog or a cat” would be interpreted as “a dog, or a cat, or both”; e.g., “a dog, a cat, or a mouse” would be interpreted as “a dog, or a cat, or a mouse, or any two, or all three”), unless: (i) it is explicitly stated otherwise, e.g., by use of “either . . . or,” “only one of,” or similar language; or (ii) two or more of the listed alternatives are mutually exclusive within the particular context, in which case “or” would encompass only those combinations involving non-mutually-exclusive alternatives. For purposes of the present disclosure and appended claims, the words “comprising,” “including,” “having,” and variants thereof, wherever they appear, shall be construed as open ended terminology, with the same meaning as if the phrase “at least” were appended after each instance thereof.

In the appended claims, if the provisions of 35 USC § 112 ¶6 are desired to be invoked in an apparatus claim, then the word “means” will appear in that apparatus claim. If those provisions are desired to be invoked in a method claim, the words “a step for” will appear in that method claim. Conversely, if the words “means” or “a step for” do not appear in a claim, then the provisions of 35 USC §112 ¶6 are not intended to be invoked for that claim.

The Abstract is provided as required as an aid to those searching for specific subject matter within the patent literature. However, the Abstract is not intended to imply that any elements, features, or limitations recited therein are necessarily encompassed by any particular claim. The scope of subject matter encompassed by each claim shall be determined by the recitation of only that claim.

What is claimed is:

1. A connector assembly for an optical fiber, the connector assembly comprising:
a unitary connector body having (i) an integrally formed axial ferrule channel formed therethrough and (ii) an integrally formed transverse passage connecting the ferrule channel and an outer surface of the connector body; and
a fiber ferrule positioned at least partly within the ferrule channel, said ferrule having (i) an axial fiber channel formed therethrough and (ii) a transverse ferrule groove on an outer surface thereof,
wherein the fiber ferrule is positioned so that a volume defined by the ferrule groove and a surface of the ferrule channel communicates with the transverse passage.

2. The connector assembly of claim 1 further comprising a retaining member positioned at least partly within the ferrule groove and at least partly within the transverse passage, wherein said retaining member comprises (i) hardened material that had flowed, prior to hardening, through the transverse passage into the ferrule groove and (ii) hardened material that had flowed, prior to hardening, into the transverse passage.

3. The connector assembly of claim 2 wherein the hardened material comprises cured polymer, reflowed polymer, reflowed solder, reflowed glass, or fused glass frit.

4. The connector assembly of claim 2 wherein the ferrule groove extends only partly around a transverse perimeter of the ferrule, so that the retaining member limits rotation of the ferrule within the ferrule channel about an axis parallel to the axial fiber channel.

5. The connector assembly of claim 1 wherein the unitary body has an integrally formed transverse channel groove on the ferrule channel surface positioned so that a volume defined by the channel groove and a surface of the ferrule communicates with the volume defined by the ferrule groove and the surface of the ferrule channel.

6. The connector assembly of claim 5 wherein the volume defined by the channel groove and a surface of the ferrule communicates with the transverse passage.

7. The connector assembly of claim 5 further comprising a retaining member positioned at least partly within the ferrule groove and at least partly within the channel groove, wherein said retaining member comprises hardened material that had flowed, prior to hardening, through the transverse passage into the ferrule groove and into the channel groove.

8. The connector assembly of claim 7 wherein the hardened material comprises cured polymer, reflowed polymer, reflowed solder, reflowed glass, or fused glass frit.

9. The connector assembly of claim 7 wherein the ferrule groove extends only partly around a transverse perimeter of the ferrule or the channel groove extends only partly around a transverse perimeter of the ferrule channel, so that the retaining member limits rotation of the ferrule within the ferrule channel about an axis parallel to the axial fiber channel.

10. The connector assembly of claim 1 further comprising a ferrule sleeve attached to the unitary body in a substantially coaxial arrangement with the fiber ferrule.

11. The connector assembly of claim 10 wherein at least a portion of the fiber ferrule is positioned within the ferrule sleeve and at least a portion of the ferrule sleeve is not occupied by the fiber ferrule.

12. The connector assembly of claim 1 further comprising an optical fiber positioned within the fiber channel.

13. The connector assembly of claim 1 further comprising a housing attached to or integrally formed with the unitary body.

14. The connector assembly of claim 1 further comprising a connecting member attached to or integrally formed with the unitary body, said connecting member being arranged to engage and retain a mating connector component or assembly.

15. A method for making a connector assembly for an optical fiber, the method comprising positioning a fiber ferrule at least partly within a ferrule channel formed through a unitary connector body, wherein:
the unitary connector body has (i) the integrally formed axial ferrule channel formed therethrough and (ii) an integrally formed transverse passage connecting the ferrule channel and an outer surface of the connector body;
the fiber ferrule has (i) an axial fiber channel formed therethrough and (ii) a transverse ferrule groove on an outer surface thereof; and
the fiber ferrule is positioned so that a volume defined by the ferrule groove and a surface of the ferrule channel communicates with the transverse passage.

16. The method of claim 15 further comprising:
flowing material (i) into the transverse passage and (ii) through the transverse passage into the ferrule groove; and
after flowing the material, allowing or causing the flowed material to harden to form a retaining member positioned at least partly within the ferrule groove and at least partly within the transverse passage.

17. The method of claim 16 wherein the hardened material comprises cured polymer, reflowed polymer, reflowed solder, reflowed glass, or fused glass frit.

18. The method of claim 14 wherein the unitary body has an integrally formed transverse channel groove on the ferrule channel surface positioned so that a volume defined by the channel groove and a surface of the ferrule communicates with the volume defined by the ferrule groove and the surface of the ferrule channel.

19. The method of claim 18 further comprising:
flowing material through the transverse passage into the ferrule groove and the channel groove; and
after flowing the material, allowing or causing the flowed material to harden to form a retaining member positioned at least partly within the ferrule groove and at least partly within the channel groove.

20. The method of claim 19 wherein the hardened material comprises cured polymer, reflowed polymer, reflowed solder, reflowed glass, or fused glass frit.

21. A method for making a connector assembly for an optical fiber, the method comprising forming through a unitary connector body (i) an integrally formed axial ferrule channel and (ii) an integrally formed transverse passage connecting the ferrule channel and an outer surface of the connector body, the channel and the passage being arranged so that with a fiber ferrule positioned at least partly within the ferrule channel, said ferrule having (i) an axial fiber channel formed therethrough and (ii) a transverse ferrule groove on an outer surface thereof, a volume defined by the ferrule groove and a surface of the ferrule channel communicates with the transverse passage.

22. The method of claim 21 further comprising forming the transverse ferrule groove on the fiber ferrule.

23. The method of claim 21 further comprising forming a transverse channel groove on the ferrule channel surface of the unitary body, the channel groove and the ferrule groove being arranged so that with the fiber ferrule positioned at least partly within the ferrule channel a volume defined by the channel groove and a surface of the ferrule communicates with the volume defined by the ferrule groove and the surface of the ferrule channel.
